(19) United States
(12) Patent Application Publication
(10) Pub. No.: US 2013/0290050 A1
(43) Pub. Date: Oct. 31, 2013

(54) SYSTEM AND METHOD FOR ASSESSING EMPLOYABILITY OR ADMITABILITY OF AN INDIVIDUAL AND ENABLING MODIFICATION OR REMOVAL OF RELATED INFORMATION

(71) Applicant: NetClarify, Inc., Gainesville, FL (US)

(72) Inventors: ADAM J. GROSS, Gainesville, FL (US); ARNOLD A. HEGGESTAD, Gainesville, FL (US); JON L. MILLS, Gainesville, FL (US); GLENN W. STURM, Atlanta, GA (US)

(21) Appl. No.: 13/846,142

(22) Filed: Mar. 18, 2013

Related U.S. Application Data
(60) Provisional application No. 61/620,214, filed on Apr. 4, 2012.

(51) Int. Cl. G06Q 10/06

(52) U.S. Cl. CPC G06Q 10/06393
USPC 705/7.13

(57) ABSTRACT

Systems and methods are provided for assessing the employability or admitability of a user from a search report and enabling modification of a user's perceived identity to enhance employability. A questionnaire is provided to a user and the answers are parsed to create key terms, which are used to create search queries. The search queries are provided to search engines that are capable of searching databases including, but not limited to, public records, private records, social media and criminal records. The results are compiled and analyzed to generate a report card along with a report catalog containing some or all information and content returned from the search. A user can make selections on the report card and report catalog indicating adverse, incorrect, erroneous or mistaken information through a user interface. Countermeasures are provided to the user according to the selections made by the user and a countermeasure matrix indicating possible solutions.

### BACKGROUND OF THE INVENTION

Employers and institutions often utilize strict hiring and admissions requirements to recruit new candidates. Employers have been known to not hire candidates based upon information they have discovered in public records or on social networking sites. It is anticipated that employers and institutions of higher learning will search public records and social media to discover information about potential applicants to an increasing extent as time passes. Unfortunately, the information provided from a search may not always be accurate or reliable.

Also, with the prevalence of social media platforms, publically available information related to an individual can be generated by others without the individual's consent or knowledge thereof. Pseudo accounts and false identities can also have disparaging effects on an individual's online identity. Outdated, incorrect and misleading information can hurt individuals applying to jobs and graduate school programs. Thus, it can be important to not only be able to review the information available about an individual that can affect admission or employability, but to also correct inaccuracies or remove details from publicly available sites that should be private.

### BRIEF SUMMARY OF THE INVENTION

Systems and methods are disclosed herein for assessing the employability or admitability of a user and modifying the user's online perceived identity to enhance employability or admitability through the deployment of countermeasures.

According to one aspect of the invention, a system and method is provided for reviewing and analyzing information from social, criminal, or other resources in order to inform a user of employability or admitability. In one embodiment, an employability or admitability report is generated by evaluating language used by, and about, a user. In further embodiments, financial, criminal, and/or affiliation information is evaluated as part of the employability or admitability report.

According to another aspect of the invention, an interface is provided by which a user can enhance, modify, correct, and/or address items from the employability or admitability report, the interface including options and methods to deploy countermeasures.

According to one embodiment, a questionnaire is provided to a user in order to obtain information relevant to determining the employability or admitability of the user. The information input by the user in response to the questionnaire is then parsed to create at least one relevant search query for performing a search of network-accessible content related to the user. The network-accessible content can include, but is not limited to, content contained in public records, private records, social media, and criminal records. Once a search is performed and the results from the various network-accessible content are compiled, the search results are analyzed according to benefits or detriments for a particular industry, organization, or educational institution to generate an employability and/or admitability report card along with a report catalog containing information and content returned from the search.

The report card provides a grading or scoring of various aspects of a user's online perceived identity relevant to employability or admitability. The report card can include itemized aspects including, but not limited to, a personal information score, an education and employment history score, a web and social media presence score, a criminal activity score, a financial history score, an affiliations score, an admitability score, an employability score, a public records score (e.g., an overall score or evaluation of available records) and a listing of the inappropriate or negative language discovered to be associated with the user. In contrast to the report catalog containing information and content returned from the search, the report card indicates a score or ranking. A calculated probability for success in neutralizing adverse information, a calculated probability for the accuracy of information and content returned, a qualitative assessment of visibility of the user's information and content to the average online researcher, and a qualitative assessment of the severity of the information and content can be provided in the report card. The report card can also contain supporting information that was used in the analysis to determine the score or ranking and may include a summary of the information obtained from the search results.

In a further embodiment, a user interface is provided. A countermeasure matrix is used to generate an action or suggestion to the user via the user interface according to a user's input regarding a result located in the report card and the report catalog. For example, the user interface can enable a user to indicate that a particular result is adverse, incorrect, erroneous or mistaken; and can provide (according to the countermeasure matrix) one or more selections to the user regarding possible actions that can be taken based upon the indication by the user for the particular result. Other input fields may be included in the user interface to facilitate deployment and selection of countermeasures.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a block diagram of a system for assessing the employability or admitability of a user and modifying the user's online perceived identity to enhance the employability or admitability of the user according to an embodiment of the invention.

FIG. 2 shows a flowchart of the process for assessing the employability or admitability of a user and generating a report card and catalog according to an embodiment of the invention.

FIG. 3 shows a flowchart of the process for modifying a user's online perceived identity according to an embodiment of the invention.

FIGS. 4A-4D illustrate a user interface in accordance with certain embodiments of the invention.

FIG. 5 shows a diagram of a computer environment on which a system for evaluating and modifying a perceived online identity for employability or admitability of a user in accordance with an embodiment of the invention can be provided.

### DETAILED DISCLOSURE

Systems and methods are disclosed herein for evaluating the employability or admitability of a user. In accordance with various embodiments of the invention, the systems and methods provide an assessment of the employability or admitability of a user and enable the modification of the user's online perceived identity to enhance employability or admitability through the deployment of countermeasures.

As used herein a user's “online perceived identity” refers to how the user's personality, reputation, and other characteristics associated with identifying the user are perceived by those viewing aspects of the user available over the Internet. A user's online perceived identity may include features that are not, in reality, associated with the user's true identity, are incorrect, or are exaggerated. For example, a user's online perceived identity may be a result of role-playing or assuming a particular persona, as is common in the entertainment industry where an actor's perceived identity is different than the true personality and character of the actor. As another example, a user's online perceived identity may be incorrect by having mistaken or overlapped identities, such as where a user has a same name as another person and certain aspects attributed to the user should really be associated with the other person and vice versa. As yet another example, a user's online perceived identity may include aspects that are exaggerated, such as where a social media site only shows the user with alcohol in hand and out at a bar where, in fact, the user only rarely drinks and/or goes to bars.

According to a certain embodiment, a system is provided that performs Internet profiling, research and evaluation for generating a report card and catalog relating to employability or admitability, as well as enabling modification of the research and evaluation results.

“Admitability” refers to the capability or worthiness of a user being admitted or accepted into a university, institution or organization. Analogously, “employability” refers to the capability or worthiness of a user being employed. The employability may be for a particular field or industry.

In one embodiment, the system includes two modules, a diagnostic module and a countermeasure module. The diagnostic module can provide users with a thorough search report card relating to employability or admitability and a catalog of information related to the user obtained via the Internet, social media and public websites. The report card can include, but is not limited to, a personal information score, an education and employment history score, a web and social media presence score, a criminal activity score, a financial history score, an affiliations score, a general admitability score, an admitability score for the institution(s) of interest to the user, a general employability score, an employability score for the profession(s) of interest to the user, and a listing of a selected some or all inappropriate or negative language and/or other content discovered to be associated with the user. Inappropriate language includes language that is deemed to be offensive in a particular setting or for a particular culture or social convention. Inappropriate language may include references to body parts (and their nicknames) generally kept private, words relating to excretions of the body, religion-related words (e.g., damn, hell), and sexually charged words.

In certain embodiments, the countermeasure module provides users with a selection of remedies for modifying or removing content and information found on the Internet that could have an adverse effect on the employability or admitability of the user. In a further embodiment, the countermeasure module can include a user interface corresponding to the report card and catalog provided by the diagnostic module, enabling countermeasure selection and deployment. The interface can present options available to the user should the user believe an item on the report card and/or report catalog is incorrect or even a true item that can still be removed or modified. In one embodiment, the interface enables a user to indicate whether each item is correct or incorrect and presents options to the user should the user indicate via the interface that the user would like an item to be removed. In certain cases, a user can purchase form letters via the interface that are auto-filled (or filled via user prompts) with particular information so that the user (or the system or a third party) can send the letter to a particular source of incorrect or undesirable items. In some embodiments, the user is directed to an attorney or other third party to handle communications or actions on behalf of the user.

In accordance with various aspects of the invention, the systems and methods described herein have applications for users including, but not limited to, students applying for admission to college, students enrolled in college who are seeking admission to graduate institutions and/or employment, career advancers or users already in the labor market that are seeking to make a career move; and employees wanting to maintain their employment.

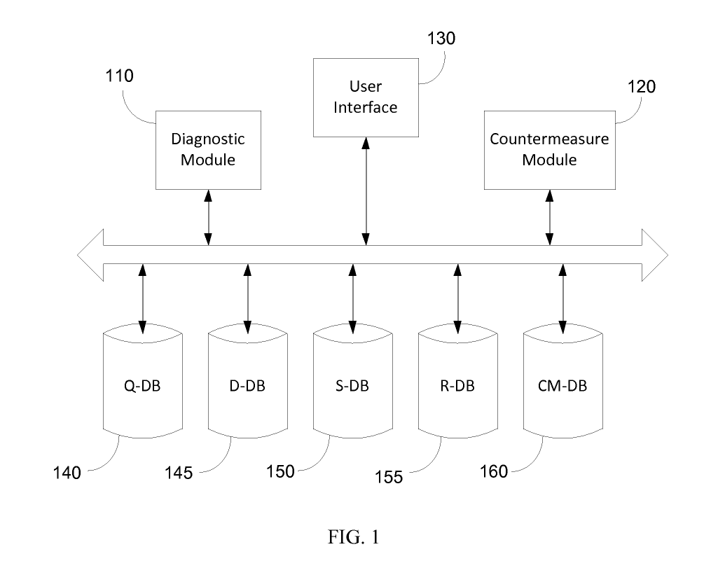

FIG. 1 shows a block diagram of a system for assessing the employability or admitability of a user and modifying the user's online perceived identity to enhance the employability or admitability of the user according to an embodiment of the invention.

Referring to FIG. 1, the system can include a diagnostic module 110, a countermeasure module 120, and a user interface 130.

The diagnostic module 110 is configured to provide a questionnaire to a user and receive the input to the questionnaire from the user via the user interface 130. The questions of the questionnaire can include, but are not limited to, personal, educational, professional, and social topics. For example, questionnaire can request a user's name and aliases; details regarding the user's work history; details regarding a user's lifestyle such as social media participation, membership or association with a charitable organization, and wiki, message board or chatroom membership/participation; date and place of birth; information on family members; court and criminal history; identification numbers; email addresses; phone numbers; or a combination thereof. The questionnaire can include input fields by which a user is prompted to supply information. In accordance with various embodiments of the invention, the questionnaire is formulated to gain information about the user's past experiences in life, educational history and professional background. The questions for the questionnaire can be stored in a question database (Q-DB) 140 and the particular questions presented to the user can be selected according to the particular report card being requested by the user. For example, certain questions such as “What University are you applying to?” may be included for generating an admitability report while other questions such as “What profession are you interested in?” may be included for generating an employability report.

The input to the questionnaire from the user provides the diagnostic module of the system with information about the user to enable a specialized search.

The user interface 130 can be accessed by the user through a local computer system such as a computer or mobile communication device. The computer can include the conventional desktop computer or laptop computer having a visual display and a keyboard and mouse or pointer as input devices. The mobile communication device can be in the form of a tablet personal computer or smartphone device having a touchscreen in which the display acts as an input device to receive information from a user via hand gestures and finger movements.

The input to the questionnaire can be stored in a diagnostic module database (D-DB) 145. In another embodiment of the invention, the questionnaire can be in paper form for the user to fill out by hand. Once completed, the responses can be scanned and uploaded to the diagnostic module 120. When the scanned responses are not uploaded in text-selectable form, the scanned responses can undergo text/character recognition before being stored in the diagnostic module database 145.

The diagnostic module 110 is configured to parse the information/responses stored in the diagnostic module database to generate at least one search query, provide the search query to at least one search engine, receive the results of the search performed via the at least one search engine, and store the results of the search in the search result database (S-DB) 150. In certain embodiments, the diagnostic module 110 then performs an analysis of the search results stored in the search result database 150 according to the benefit/detriment for a particular or general industry, organization, or educational institution in order to generate a report card, the content of which can be stored in a report card database (R-DB) 155.

In one embodiment, the diagnostic module 110 compiles the search results and arranges the search results to provide a cohesive report card. The diagnostic module may also analyze the search results for the existence of inappropriate language (or other predetermined words or images). In a further embodiment, indicators or flags are assigned to certain search results during an analysis of the search results performed by the diagnostic module 110. In another embodiment, the diagnostic module 110 communicates with a result analysis engine such as a language engine, which may evaluate the search results for sentiment (e.g., determining emotional state or assigning polarity via natural language processing and other computational analytics) and provide the results of the analysis back to the diagnostic module 110. In certain cases, the diagnostic module 110 receives search results that are pre-flagged from one or more of the search engines queried.

The report card and a catalog including the search results stored in the search result database 150 can be provided to the user via the user interface 130. In one embodiment, the report card and/or catalog can be provided to the user via an email or message over a network to the user's local computer system instead of via the user interface 130. In another embodiment, a hard copy of the report card and catalog can be printed and/or mailed to the user.

The countermeasure module 120 is configured to provide output of a countermeasure matrix to the user, via the user interface 130. The user interface enables a user to indicate whether each item is correct or incorrect and presents options to the user (based on the countermeasure matrix) should the user indicate via the interface that the user would like an item to be modified. The various features of the countermeasure matrix can be stored in a countermeasure matrix database (CM-DB) 160.

For each item upon which the report card is generated (and, in certain embodiments, even those items not used in the report card but still provided in the search result catalog) an input field for the user can be provided to establish whether the user believes the item to be true, false, or an overlapped identity (e.g., the item is discussing someone else, not the user). In some embodiments, an input field is also provided for the user to indicate the source of the item. In another embodiment, the countermeasure module 120 analyzes the search results to determine the source of the item. Based upon the inputs provided to the input fields via the user interface 130, the countermeasure module 120 provides recommendations according to the countermeasure matrix. In one embodiment, the countermeasure module 120 evaluates and provides a response for possible courses of action for each item the user selects as wanting to have removed from the source. For example, an item indicated as “true” and having a source of a social media site can receive a response according to the countermeasure matrix including recommendations for how to have the item removed from the social media site (which may include suggesting contacting an attorney for legal advice), while an item indicated as “true” and having a source of a criminal record can receive a response according to the countermeasure matrix that the item is unchangeable.

The countermeasure matrix can include selections for enabling a user to remove or correct an item of the report catalog at a source of the item. The source of the item can include the database from which the item originates or an agent having control of the database in which the item is stored.

The countermeasure module 120 can provide a countermeasure (such as a countermeasure letter) as one remedy to clarify the adverse information. The countermeasure module 120 can also provide an unchangeability notification if the adverse information is determined uncorrectable or outside the scope of protection that a countermeasure can provide.

In certain cases, a user can purchase form letters via the interface that are auto-filled (or filled via user prompts) with particular information so that the user can send the letter (or request the letter to be sent) to a particular source of incorrect or undesirable items.

In other cases, the countermeasure module 120 informs the user to contact an attorney or other third party in order to have a letter or other communication sent to the particular source of incorrect or undesirable items. In one embodiment, the countermeasure module 120 can output (and/or transmit) the user's information (and, in certain cases, the results of the search report) to the attorney or third party upon the request of the user.

The question database 140, diagnostic module database 145, search result database 150, report card database 155 and countermeasure module database 160 can be stored on the same or separate storage devices.

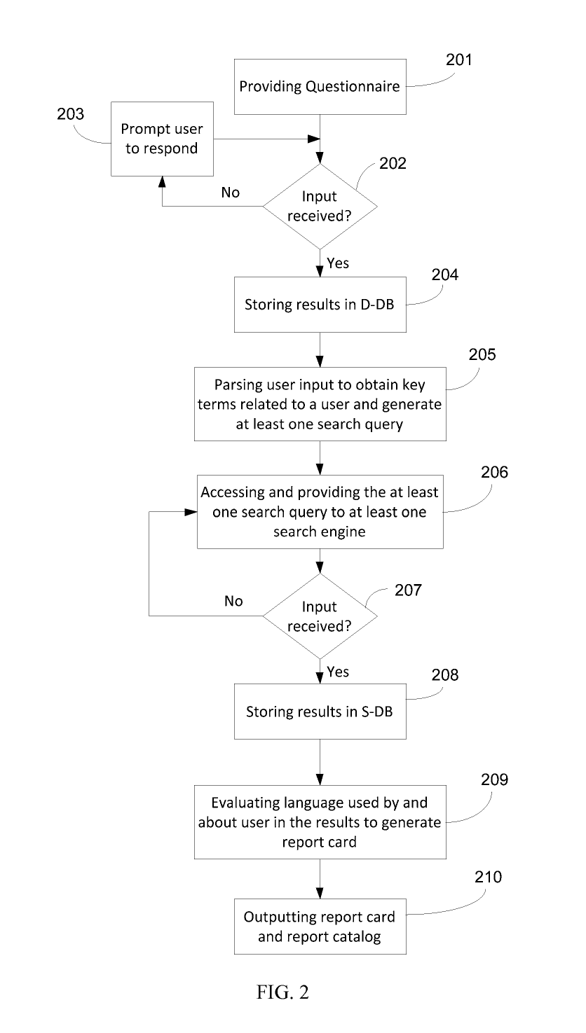

FIG. 2 shows a flowchart of the process for assessing the employability or admitability of a user and generating a report card and catalog according to an embodiment of the invention. The method described with respect to FIG. 2 can be carried out via the system described with respect to FIG. 1. As shown in FIG. 2, a process for creating a report card and catalog can include providing a questionnaire to a user (201); if no input is received (202), prompting the user to respond to a question on the questionnaire (203); if input is received (202), storing the input in a database D-DB (204); parsing the user input to obtain key terms related to the user and generate at least one search query (205); accessing and providing the at least one search query to at least one search engine (206); if results are not received from the search engine query (207), performing the accessing and providing of the least one search query to at least one search engine again via a same or different search engine using a same or different search query; if results are received from the search engine query (207), storing the results of the search query in a database S-DB (208); evaluating language used by and about the user in the results to generate a report card (209); and outputting the report card and report catalog (210).

In step 206, at least two different types of search engines are accessed and the results then merged when generating the report card (209). One of the search engine types utilized by the methods and systems of certain embodiments of the invention is one that searches (or specializes in) social media whereas the other of the search engine types is one that searches (or specializes in) searching public records and/or personal affiliations (e.g., membership in an organization). For example, in one embodiment, at least one search engine specializing in publically available records and social media is used and at least one search engine specializing in criminal records and private records is used.

According to certain embodiments, the systems carrying out methods of the invention access existing search engines and provide the existing search engines with search queries in order to search network-accessible records, public records databases, organizational membership rosters, conventional media (e.g., newspaper website, news station website), blogs, and social media websites (e.g., Facebook®, Twitter®, MySpace®, and LinkedIn®) to retrieve information and content related to the user. The results of the search can include, but are not limited to, information, images, and video associated with the user. Information and content related to the user can include, but is not limited to, personal records, public records, blog posts, criminal records, financial history, professional affiliations, publications, images and videos, and content from social media, conventional media, news articles and organizational membership rosters.

In various embodiments, public search engines and private search engines may be used. Public search engines include, but are not limited to, Google®, Yahoo! ®, and Bing®. Private databases include, but are not limited to, LexisNexis® and Westlaw®.

In some embodiments, results from one query can be used to create secondary queries. The secondary queries can then be provided to the same or additional search engines to obtain additional results.

In step 208, the results returned from the various search engines are stored in a database. In accordance with the invention, the varied results are merged and evaluated as a whole in order to generate the report card during the evaluation step 209.

During the evaluation step 209, an analysis can be conducted on the search results according to the benefit or detriment for a particular industry, organization, or educational institution. The analysis can be based on metrics compiled according to what a particular industry indicates as being aspects detrimental to or benefiting an employee and the hiring patterns associated with that particular industry. In another embodiment, an analysis is carried out with respect to general employability. The language (or images) can be evaluated as to the benefit or detriment of the employability or admitability of the user and a report card can be generated. In one embodiment, inappropriate language or other predetermined terms or images can be searched and evaluated according to predetermined metrics. In a further embodiment, the language (or images) can be evaluated to determine associated sentiment. The sentiment evaluation may be performed by a language engine that is either a third party in communication with the system or a part of the system.

The report card can include one or more of the following: a personal information score, an education and employment history score, a web and social media presence score, a criminal activity score, a financial history score, an affiliations score, an admitability score for the institution(s) of interest to the user, an employability score for the profession(s) of interest to the user, and a listing of some or all inappropriate or negative language and/or other content discovered to be associated with the user.

In one embodiment, an employability or admitability score is calculated. The employability or admitability score can be an indicator of whether the results returned from the search could be adverse to the employment prospects or admission prospects of the user.

Results that may appear to have negative connotations to a user's reputation do not necessarily equate to a negative employability score. For example, it may be advantageous for a user to have content illustrating the user scantily clad (posing topless or wearing a bikini bathing suit) if an employability report is being produced for employment in the field of bathing suit modeling. Similarly, negative statements about a user can also be an indication of the user's frame, which may be a benefit for the entertainment industry. In such a case, the quantity of comments would provide a higher employability score regardless of the content of the comments.

As mentioned above, in addition to an admitability or employability score, the evaluating step can analyze the search results to address various aspects that can be relevant to employability or admitability; and can calculate scores including, but not limited to, a personal information score, an education and employment history score, a web and social media presence score, a criminal activity score, a financial history score, an affiliations score, an admitability score, an employability score, and/or a listing of some or all the inappropriate or negative language and/or other content discovered to be associated with the user.

The evaluating step can also analyze the search result to provide a calculated probability for success in neutralizing adverse information, a calculated probability for the accuracy of information and content returned, a qualitative assessment of visibility of the user's information and content to the average online researcher, and a qualitative assessment of the severity of the information and content.

In an embodiment of the invention, the various scores contained within the report card can be a quantitative representation of a user's employability or admitability based on the search results obtained. For example, scores can be provided on a scale of 0 to 100.

In another embodiment of the invention, the various scores contained within the report card can be qualitative representations of a user's employability or admitability based on the search results obtained. For example, scores can be provided as grades on a scale of F to A, where there are ‘+’ and ‘−’ intervals associated with each letter grade from F to A. In another example, qualitative words may be used. For example, a criminal activity score can be ‘low,’ ‘high’ or ‘dangerous’.

In yet another embodiment, the various scores contained within the report card can include a quantification of the number of items deemed as negative for each aspect being analyzed. In a case where results are flagged (e.g., according to inappropriate language and/or predetermined criteria), the number of flags can be provided as part of the report card.

The search results obtained during step 207 may include results relating to individuals (or entities) other than the user. Accordingly, by providing a report catalog along with the report card, a user can review the information and content retrieved from the search and determine the adverse or inaccurate information along with the source of the information or content.

In order to correct and/or improve the scores on the report card, various embodiments of the invention provide systems and methods for modifying a user's online perceived identity.

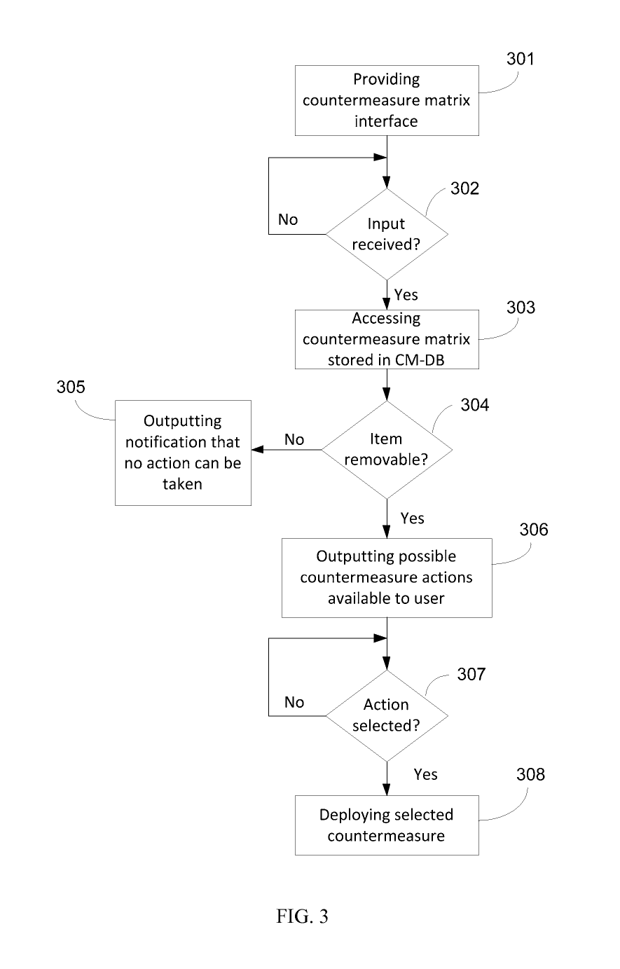

FIG. 3 shows a flowchart of the process for modifying a user's online perceived identity according to an embodiment of the invention.

In one embodiment, a method for modifying a user's online perceived identity includes: providing a countermeasure matrix interface (e.g., a user interface by which inputs from a user are evaluated according to the countermeasure matrix and outputs are provided to the user) corresponding to items in the report card and/or report catalog (301), the countermeasure matrix interface enabling countermeasure selection and deployment; receiving input from a user via the countermeasure matrix interface as to whether the information and content related to the user is accurate and/or whether the user would like the content removed at the source (302); accessing a countermeasure matrix stored in a CM-DB according to the input from the user (303); if the countermeasure matrix indicates the content is not removable or able to be modified (304), outputting a notice that no action can be taken (305); if the countermeasure matrix indicates the content is removable or able to be modified (304), outputting information regarding at least one countermeasure action according to whether the input for an item indicates the item is accurate and the user would like the content removed at the source (306), the at least one countermeasure action being selectable by the user and provided as an option to the user according to the countermeasure matrix stored in the CM-DB; receiving a selection of a countermeasure action by the user (307); and deploying the selected countermeasure action (308).

In certain embodiments, the countermeasure matrix interface can be populated with items from the report card and/or report catalog or items of the report card and presented as an interactive report card and catalog.

The countermeasure matrix interface can include input fields for the user to indicate whether, for example, the information and content related to the user is true, false, erroneous, or derived from an overlapping or mistaken identity. In certain embodiments, input fields can be provided for the user to indicate the source of the content (e.g., the site or owner of the content, the person making an adverse statement, reason or location of criminal offense). In other embodiments, the source of the content can be automatically determined by analyzing the search results or can be provided along with the search results. The countermeasure matrix interface can also include input fields for a user to indicate whether the user desires to remove the content (regardless of the content being adverse or even affecting the report card score). For example, the user can choose whether he or she would like to take no action, or attempt to correct and mitigate any adverse or inaccurate information. In a further embodiment, the user can indicate a perceived degree of severity.

In step 303, the countermeasure matrix can be accessed to automatically determine whether the material related to the user is unchangeable or removable. Some information and content can be determined as unchangeable.

In one embodiment of step 303, the countermeasure matrix receives the input provided by the user and outputs the possible actions that can be taken based upon the input provided by the user. By using the countermeasure matrix, an automatic determination can be made as to whether no action can be taken or whether it may be possible to correct or mitigate adverse information or content. Adverse information includes, but is not limited to, erroneous information, biased information and incomplete information.

In steps 304 and 305, if the countermeasure matrix indicates the content is not removable or able to be modified, a response or notification can be presented to the user. In certain embodiments, the response or notification of unchangeability (305) can be in the form of an on-screen prompt delivered via the countermeasure interface, an email, text message or letter.

In one embodiment, options may be provided to the user, via the countermeasure interface, that are not actually viable options for removing a particular piece of content. In those cases, after the countermeasure matrix is accessed and the action determined as not being available, a response or notification can be presented to the user of the unavailability of the particular action.

In steps 304 and 306, if the countermeasure matrix indicates that the content is removable or able to be modified, the available options can be output to the user. Countermeasure options can include form letters including a countermeasure letter, a notification that the user should contact an attorney, and even instructions on how to contact a source and remove content.

In step 308, if a user selects a countermeasure letter as the desired countermeasure option action in step 307, the countermeasure letter can be output by the system to the user, the source, an attorney, or some other third party. The countermeasure letter can be output to/for the user via, for example, a user interface (from which the letter may be printed or downloaded), email, or mail. When the countermeasure letter or other information (e.g., information supporting an available countermeasure) is selected by the user to be output to a third party (e.g., an attorney), the system can output the letter or information in any suitable form to be received by the third party. For example, email may be used to provide the information or inform the third party that they should access the system to obtain the information.

The appropriate countermeasure letter can be provided and/or assembled from a library of pre-written form letters or components stored in a database associated with the system.

For example, the countermeasure letter can contain citations for potential legal liability on the part of the offending party using a standardized template employing any number of proprietary legal methodologies to affect the “takedown” of offensive or misleading material. A countermeasure letter may generally request the “takedown” of materials due to one or more violations of law. These violations can include, but are not limited to, slander, libel, unjust enrichment, student confidentiality, public disclosure of private facts, intrusion upon seclusion, and various other Federal Acts. Additionally, some violations may trigger the Digital Copyright Millennium Act (DCMA). Each of these items can serve as the basis for a tort, criminal investigation or monetary fine.

The letter can include a formal request for a third party to remove true or false information that may be adverse to the user. In addition to a form letter, or as an alternative, instructions can be provided to the user for correcting misinformation or false public records.

In accordance with various embodiments, available countermeasures and countermeasure letters can include instructions for the user to correct misinformation or false public records, a formal request for a third party to remove true information that may be adverse to the reputation of the user, a formal request for a third party to remove false information and noting possible liability for the third party, or a formal request for a third party to remove true information and noting possible liability for the third party.

For example, a user may determine after reviewing the search report and the search report catalog that he or she is mistaken for another individual with the same or similar name. The user can indicate the misidentification as a countermeasure selection in the countermeasure matrix, which then provides the user with possible actions (e.g., countermeasures) to correct the misidentification. One selection can include an appropriate countermeasure letter to attempt to compel the removal of a pseudo account or mistaken information.

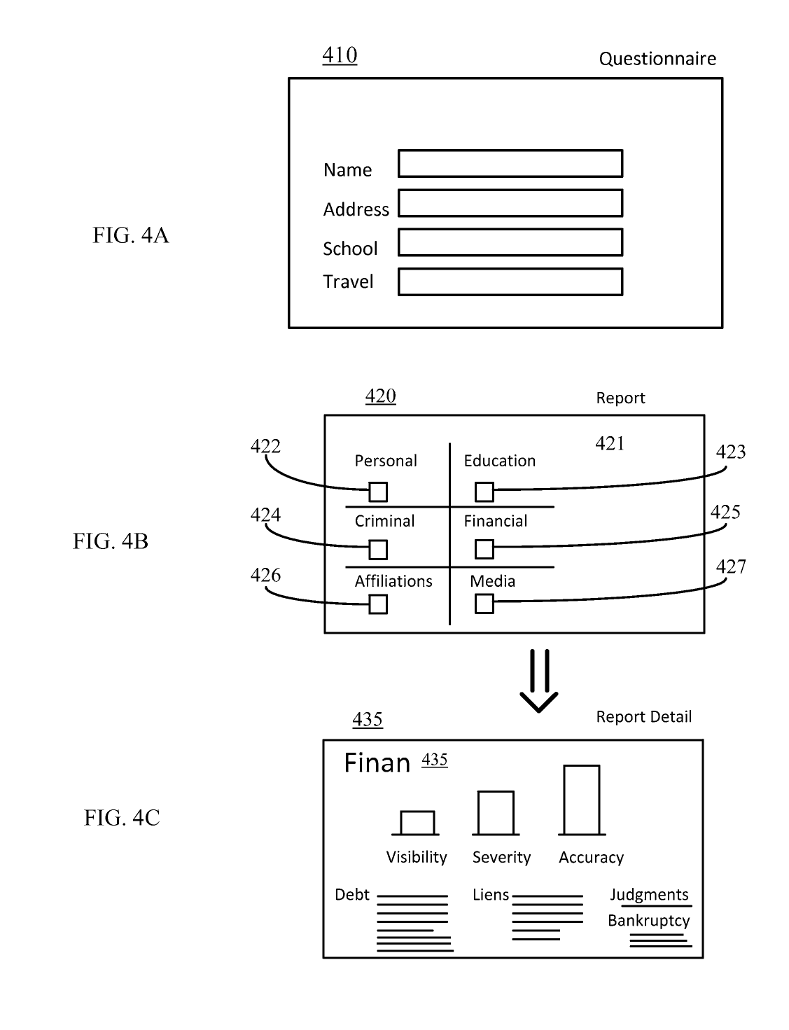

FIGS. 4A-4D illustrate a user interface in accordance with certain embodiments of the invention. Referring to FIG. 4A, a questionnaire interface 410 can be provided with questions and input fields for receiving the answers to the questions from the user. In one embodiment, a diagnostic module 110 such as described with respect to FIG. 1 can be configured to provide the questionnaire interface 410 via the user interface 130 and the particular questions asked as part of the questionnaire interface 410.

Referring to FIG. 4B, a report card interface 420 can be provided, for example, by the diagnostic module 110 such as described with respect to FIG. 1. The report card interface 420 can include a report card screen 421, which may include, for example, a personal score 422, an education score 423, a criminal score 424, a financial score 425, an affiliation score 426, and a media score 427, as well as other scores that may be of interest or relevant to the admitability or employability of the user. A user can access additional details regarding each score by appropriate selection of the region of the screen 421 containing the particular score. For example, a selection of the financial score 425 can access a report detail screen 435 such as shown in FIG. 4C.

The report detail screen can include information in the form of charts, lists, and images. In one embodiment, information can be provided via the detail screen 435 of visibility, severity, and accuracy of the items used to calculate the particular score. Details of the information and content used to generate the scoring can be provided on the detail screen 435. For example, in the financial score detail screen, details regarding debt, liens, judgments, and whether the user applied for bankruptcy can be listed. In one embodiment, these details can be considered as part of the report catalog provided with the report card.

Referring to FIG. 4D, a countermeasure interface 440 can be provided where a user can provide certain input about the content of the report card and catalog and obtain information regarding countermeasures that can be deployed (as well as request deployment of those countermeasures). In one embodiment, the countermeasure interface 440 can be provided by the countermeasure module 120 as described with respect to FIG. 1. As shown in the example of FIG. 4D, specific items such as those listed in the detail screen 435 can include first input boxes 441 for user selection of whether each item is true, false, or misidentified (e.g., “not me”). An option can also be presented for user selection as to whether, given the selection of true, false, or not me by the user from the first input boxes 441, the item can be removed. This selection can be in the form of a second input box 442 having the request “can I remove?”. The countermeasure module can provide a response to the request. The response can either be an indication or notification that nothing can be done at this time or options for countermeasures. In one embodiment, costs associated with potential countermeasures can be provided.

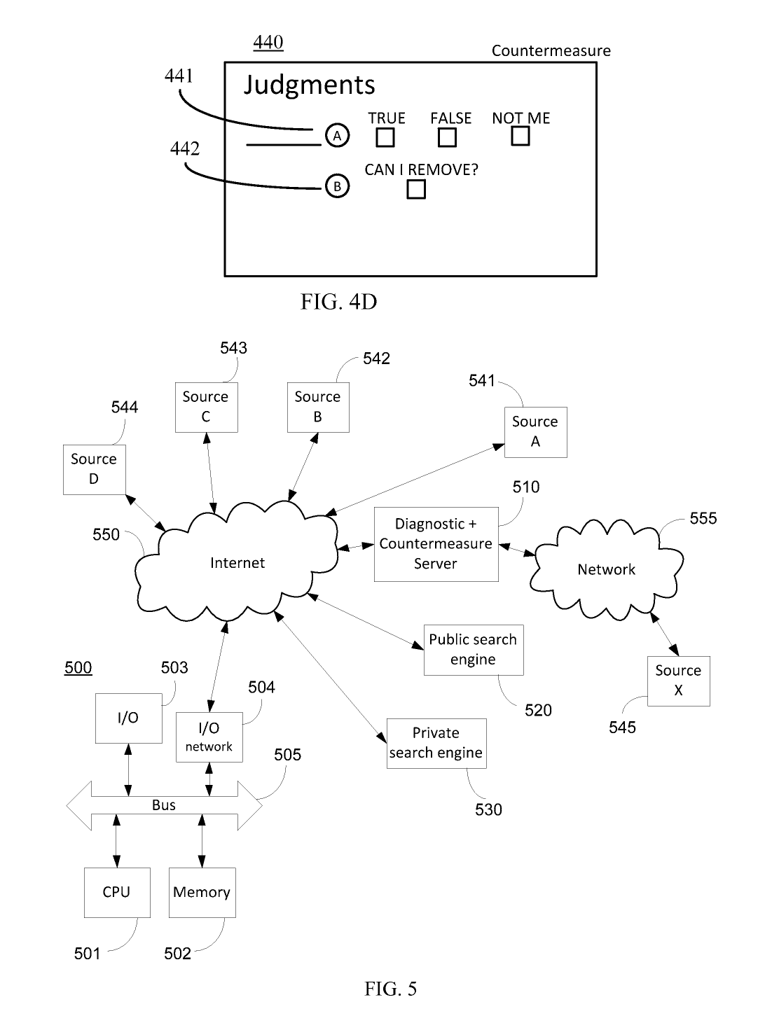

FIG. 5 shows a diagram of a computer environment on which a system for evaluating and augmenting a perceived online identity for employability or admitability of a user in accordance with an embodiment of the invention can be provided. Referring to FIG. 2, a user can access the subject system for evaluating employability or admitability via a local computer system 500. The computer system can include one or more computer processing units (CPUs) 501, computer-readable media such as memory 502 and mass storage (e.g., hard drive) (not shown), and I/O devices (e.g., network interface 503, user input devices 504) that communicate via bus 505. The computer system can include a display connected as an I/O device 504 providing a graphical user interface (GUI). The one or more CPUs 501 may include multiprocessors or multi-core processors. In certain embodiments, one or more digital signal processors (DSPs) may be included as part of the computer system in place of or in addition to a general purpose CPU.

A diagnostic and countermeasure server 510 is provided that can include at least one computer processing unit executing instructions stored in a computer-readable medium for carrying out methods of certain embodiments of the invention. In one embodiment, the diagnostic module (110 of FIG. 1) and countermeasure module (120 of FIG. 1) are carried out via the diagnostic and countermeasure server 510. In a further embodiment, the diagnostic and countermeasure server 510 hosts a website or communicates with a server hosting the website in order to provide an interface for a user to input requested information and receive results output from the diagnostic and countermeasure server 510.

The local computer system 500 can communicate with the diagnostic and countermeasure server 510 over the Internet 550 using the network interface 503 of the local computer system 500. The diagnostic and countermeasure server 510, when executing instructions for carrying out methods of certain embodiments of the invention, can communicate over the Internet 550 to carry out searches using one or more public search engines 520 and/or private search engines 530 in order to search content at a variety of sources (e.g., source A 541, source B 542, source C 543, and source D 544). In certain embodiments, the diagnostic and countermeasure server 510 communicates directly with one or more of the variety of sources. Communication between the sources, search engines, server, and local computer can be wireless or wired.

In a further embodiment, the diagnostic and countermeasure server may be connected to a content source (e.g., source X 545) over a separate network 551. The network 551 may also enable access to one or more search engines (not shown), and may be a private network.

The Internet 550 and/or network 551 can include, but is not limited to, a cellular (e.g., wireless phone) network, a local area network (LAN), a wide area network (WAN), a WiFi network, or a combination thereof. Such networks are widely used to connect various types of network elements, such as routers, servers, and gateways. It should also be understood that the invention can be practiced in a multi-network environment having various connected public and/or private networks.

As will be appreciated by those skilled in the art, communication networks can take several different forms and can use several different communication protocols. Certain embodiments of the invention can be practiced in distributed-computing environments where tasks are performed by remote-processing devices that are linked through a communications network. In a distributed-computing environment, program modules providing instructions for executing methods of certain embodiments of the invention can be located in both local and remote computer-readable media.

It should be appreciated by those skilled in the art that computer-readable media include removable and non-removable structures/devices that can be used for storage of information, such as computer-readable instructions, data structures, program modules, and other data used by a computing system/environment.

A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media capable of storing computer-readable media now known or later developed. Computer-readable media should not be construed or interpreted to include any propagating signals.

Certain techniques set forth herein may be described in the general context of computer-executable instructions, such as program modules, executed by one or more computers or other devices. Certain embodiments of the invention contemplate the use of a computer system within which a set of instructions, when executed, can cause the system to perform any one or more of the methodologies discussed above. Generally, program modules include routines, programs, objects, components, and data structures that perform particular tasks or implement particular abstract data types.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A method for evaluating employability or admitability of a user, the method comprising:
providing a user interface presenting a questionnaire to a user;
parsing input received via the user interface to generate at least one relevant search query;
performing a search of database content related to the user using the at least one relevant search query, the database content comprising at least one of Internet-accessible records, private databases, public records databases, criminal databases, and social media sites;
storing results of the search of the database content in a result database, the results being associated with the user; and
analyzing the results associated with the user stored in the result database according to a benefit and detriment for a particular industry, a particular organization, a particular educational institution, general admitability, or general employability to generate a report card.

2. The method according to claim 1, further comprising:
outputting the report card and a report catalog to the user, the report catalog comprising all results associated with the user stored in the result database.

3. The method according to claim 1, further comprising:
outputting the report card and a report catalog to the user, the report catalog comprising selected results associated with the user stored in the result database.

4. The method according to claim 3, wherein outputting the report card and the report catalog comprises:
providing a report interface.

5. The method according to claim 4, wherein the report interface comprises selections for enabling a user to remove or correct an item of the report catalog at a source of the item.

6. The method according to claim 1, wherein performing the search of database content related to the user using the at least one relevant search query comprises accessing a search engine and providing the search engine with the at least one relevant search query.

7. The method according to claim 1, wherein analyzing the results associated with the user stored in the result database according to the benefit and detriment for the particular industry, the particular organization, the particular educational institution, general admitability, or general employability to generate the report card comprises:
performing a language analysis of the results associated with the user stored in the result database to find predetermined words; and
requesting and receiving an indication of an associated sentiment for a particular result or results associated with the user stored in the result database from a language engine.

8. A computer readable medium comprising instructions stored thereon that when executed cause a processor to perform a method for evaluating employability or admitability of a user, the method comprising:
providing a user interface presenting a questionnaire to a user;
parsing input received via the user interface to generate at least one relevant search query;
performing a search of database content related to the user using the at least one relevant search query, the database content comprising at least one of Internet-accessible records, private databases, public records databases, criminal databases, and social media sites;
storing results of the search of the database content in a result database, the results being associated with the user; and
analyzing the results associated with the user stored in the result database according to a benefit and detriment for a particular industry, a particular organization, a particular educational institution, general admitability, or general employability to generate a report card.

9. The medium according to claim 8, wherein the method further comprises:
outputting the report card and a report catalog to the user, the report catalog comprising all results associated with the user stored in the result database.

10. The medium according to claim 8, further comprising:
outputting the report card and a report catalog to the user, the report catalog comprising selected results associated with the user stored in the result database.

11. The medium according to claim 10, wherein outputting the report card and the report catalog comprises:
providing a report interface.

12. The medium according to claim 11, wherein the report interface comprises selections for enabling a user to remove or correct an item of the report catalog at a source of the item.

13. The medium according to claim 8, wherein performing the search of database content related to the user using the at least one relevant search query comprises accessing a search engine and providing the search engine with the at least one relevant search query.

14. The medium according to claim 8, wherein analyzing the results associated with the user stored in the result database according to the benefit and detriment for the particular industry, the particular organization, the particular educational institution, general admitability, or general employability to generate the report card comprises:
performing a language analysis of the results associated with the user stored in the result database to find predetermined words; and
requesting and receiving an indication of an associated sentiment for a particular result or results associated with the user stored in the result database from a language engine.

15. A system for assessing employability or admitability of a user and modifying information adversely affecting the user's employability or admitability comprising:
a user interface;
a processor comprising:
a diagnostic module configured to present a questionnaire to a user via the user interface, parse input related to the questionnaire that is received via the user interface to generate at least one relevant search query; provide the at least one relevant search query to at least one search engine; receive search results from the at least one search engine; evaluate the search results according to a benefit and detriment for a particular industry, a particular organization, a particular educational institution, general admitability, or general employability; and generate a report card; and
a countermeasure module configured to provide output of a countermeasure matrix associated with the report card and a report catalog and present the output of the countermeasure matrix to the user via the user interface.

16. The system according to claim 15, wherein the countermeasure matrix comprises selections for enabling a user to remove or correct an item of the report catalog at a source of the item.
